(19) United States
(12) Patent Application Publication
(10) Pub. No.: US 2025/0056292 A1
(43) Pub. Date: Feb. 13, 2025

(54) ENERGY AWARE QOS OPTIMIZATION

(71) Applicant: NOKIA TECHNOLOGIES OY, Espoo (FI)

(72) Inventors: Ece GOSHI, Munich (DE); Borislava GAJIC, Unterhaching (DE); Daniyal Amir AWAN, Munich (DE); Péter SZILÁGYI, Budapest (HU)

(21) Appl. No.: 18/795,465

(22) Filed: Aug. 6, 2024

(30) Foreign Application Priority Data
Aug. 10, 2023 (GB) 2312242.7

(51) Int. Cl. H04W 24/10; H04W 52/02

(52) U.S. Cl. CPC H04W 24/10; H04W 52/0212

(57) ABSTRACT

Various examples of embodiments described herein relate to methods and apparatuses for improving possibilities for saving energy in a network. One such example of an embodiment relates to an apparatus, which comprises means for deriving at least one energy saving measure involving at least one user equipment, wherein the energy saving measure comprises varying the quality of service for the at least one user equipment in order to adjust energy consumption in a network, and means for sending a notification comprising at least one derived energy saving measure to a network element.

### CROSS-REFERENCE TO RELATED APPLICATIONS

This application claims priority to Great Britain Application No. 2312242.7, filed Aug. 10, 2023, the entire contents of which are incorporated herein by reference.

### TECHNICAL FIELD

Various example embodiments of this subject disclosure relate to an apparatus, a method and a computer program product for providing energy aware QoS optimization.

### BACKGROUND

The following meanings for the abbreviations used herein apply:
AI Artificial Intelligence
AMF Access and Mobility Management Function
CHF Charging Function
CM Connection Management
CN Core Network
DNN Data Network Name
ES Energy Saving
FM Fault Management
FQDN Fully Qualified Domain Name
ML Machine Learning
MnS Management Service
NAS Non-Access Stratum
NF Network Function
NSC Network Slice Consumer
NSP Network Slice Provider
NWDAF Network Data Analytics Function
PCF Policy Control Function
PDU Packet Data Unit
PGW Packet Data Network GateWay
PM Performance Management
QoS Quality of Service
SMF Session Management Function
SMS Short Message Service
SMSF SMS Function
SUPI Subscription Permanent Identifier
UDM Unified Data Management
UE User Equipment

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards (such as, those provided by 3GPP), satellite based communication systems and different wireless local networks. A wireless local network may, for example, be implemented as a wireless local area network (WLAN). The wireless systems can typically be divided into cells, and are therefore often referred to as cellular systems.

The communication system and associated devices typically operate in accordance with a given standard or specification which sets forth what the various entities associated with the system are permitted to do and how that should be achieved. Communication protocols and/or parameters which shall be used for the connection are also typically defined. An example of a set of standards are the so-called 5G standards.

### SUMMARY

Various example embodiments aim at addressing at least part of the issue and/or problems and drawbacks either explicitly described herein or otherwise apparent to a person skilled in the relevant arts to provide methods, apparatuses and computer programs by which possibilities for saving energy in a network can be improved.

Several aspects of the various example embodiments are detailed as follows:

According a first aspect of various example embodiments, an apparatus is provided which comprises
means for deriving at least one energy saving measure involving at least one user equipment, wherein the energy saving measure comprises varying the quality of service for the at least one user equipment in order to adjust energy consumption in a network, and
means for sending a notification comprising at least one derived energy saving measure to a network element.

According to various example embodiments, the at least one energy saving measure may further comprise adjusting charging based on varying the quality of service for the at least one user equipment.

According to various example embodiments, the apparatus may further comprise means for deriving charging characteristic and criteria for which the said derived charging characteristic apply for the at least one user equipment for each energy saving measure, and means for sending the derived charging characteristic and criteria with the notification to the network element.

According to various example embodiments, the apparatus may further comprise means for receiving a response notification from the network element, the response notification comprising information indicating whether the at least one user equipment will take part in the at least one energy saving measure or not, and/or whether the at least one user equipment accepts taking part in the at least one energy saving measure or not.

According to various example embodiments, the apparatus may further comprise means for initiating a control of the quality of service based on the energy saving measure.

According to various example embodiments, the apparatus may further comprise means for initiating, upon receiving and/or detecting a trigger, the control of the quality of service based on the energy saving measure.

According to various example embodiments, the apparatus may further comprise means for deriving the energy saving measure by analyzing the condition of the network and predicting an impact of the energy saving measure on the energy consumed in the network based on history information.

According to various example embodiments, the history information may be information about a relationship between network conditions, network energy saving measures, and network energy consumption.

According to various example embodiments, the apparatus may further comprise means for analyzing the condition of the network and predicting the impact of the energy saving measure by applying artificial intelligence.

According to various example embodiments, the apparatus may further comprise means for deriving the at least one energy saving measure based on quality of service optimization guidelines preconfigured in the network, and means for preparing an energy saving offer based on the energy saving measure.

According a second aspect of various example embodiments, an apparatus is provided which comprises
means for receiving a notification comprising at least one energy saving measure involving at least one user equipment, wherein the at least one energy saving measure comprises varying the quality of service for the at least one user equipment in order to adjust energy consumption in a network,
means for selecting at least one user equipment for taking part in the at least one energy saving measure,
means for determining whether the selected at least one user equipment will take part in the energy saving measure, and
means for applying the at least one energy saving measure for the selected at least one user equipment based on determining that the at least user equipment will take part in the energy saving measure.

According to various example embodiments, the energy saving measure may further comprise adjusting charging based on varying the quality of service for the at least one user equipment.

According to various example embodiments, the apparatus may further comprise means for sending information as to whether the selected at least one user equipment will take part in the at least one energy saving measure to a network element having sent the notification.

According to various example embodiments, the apparatus may further comprise means for determining whether the determined at least one user equipment will take part in the energy saving measure or not by sending a proposal for taking part in the energy saving measure to at least one determined user equipment, and receiving a response message from the user equipment.

According to various example embodiments, the apparatus may further comprise means for sending the proposal for taking part in the energy saving measure to the user equipment in a packet session modification command.

According to various example embodiments, the proposal may comprise information about the change in quality of service as well as an impact on the charging in a human or machine readable format.

According to various example embodiments, the apparatus may further comprise means for determining whether the selected at least one user equipment will take part in the at least one energy saving measure or not by accessing user equipment subscription data information stored in a network element.

According to various example embodiments, the user equipment subscription data information may comprise
information as to whether the user equipment agrees to take part in adjusting energy consumption in a network or not, and/or
information as to whether the user equipment agrees to take part in a certain energy saving measure or not, and/or
information as to whether the user equipment is to be notified about the energy saving measure that will be applied, and/or
information as to whether the user equipment is to be requested to verify whether the user equipment will take part in the energy saving measure before applying the energy saving measure, and/or
information as to whether the user equipment agrees to take part in adjusting energy consumption in a network or to take part in a certain energy saving measure during a predetermined time period and/or at a specific location and/or within a specific network slice.

According to various example embodiments, the apparatus may further comprise means for sending, before applying the energy saving measure, a request to the user equipment to verify whether the user equipment will take part in the energy saving measure, in case: user equipment subscription data information comprises information that the user equipment is to be requested to verify whether the user equipment will take part in the energy saving measure before applying the energy saving measure, or when the request is pre-configured in the network.

According to various example embodiments, the apparatus may further comprise means for sending, before applying the energy saving measure, an information to the user equipment that user equipment will take part in the energy saving measure, in case: user equipment subscription data information comprises information that the user equipment is to be notified about the energy saving measure that will be applied, or when sending the information is pre-configured in the network.

According to various example embodiments, the apparatus may further comprise means for selecting the at least one user equipment based on information received from the network element.

According to various example embodiments, the information received from the network element may comprise for each energy saving measure charging characteristics and criteria for which the said derived charging characteristics apply for the at least one user equipment.

According to various example embodiments, the apparatus may further comprise means for selecting at least one network element involved in the at least one energy measure based on the information received from the network element.

According a third aspect of various example embodiments, an apparatus is provided which comprises
means for receiving a proposal for taking part in an energy saving measure, the proposal comprising information about at least one energy saving measure involving the user equipment, wherein the energy saving measure comprises varying the quality of service for the user equipment in order to adjust energy consumption in a network,
means for determining whether to accept the proposal or not, and
means for sending a response including information indicating whether the proposal is accepted or not.

According to various example embodiments, the energy saving measure may further comprise adjusting charging based on varying the quality of service for the at least one user equipment.

According to various example embodiments, the proposal may comprises a request to verify whether the user equipment will take part in the energy measure, and the apparatus may further comprise means for determining whether to accept the proposal or not by verifying the proposal.

According to various example embodiments, the proposal may comprise a plurality of energy saving measures, and the apparatus may further comprise means for selecting one energy saving measure from the plurality of energy measures.

According to various example embodiments, the apparatus may further comprise means determining whether to accept the proposal or not based on a pre-configuration, or receiving user or machine input on whether or not to accept the offer, or by performing a predetermined process.

According a fourth aspect of various example embodiments, a method is provided which comprises
deriving at least one energy saving measure involving at least one user equipment, wherein the energy saving measure comprises varying the quality of service for the at least one user equipment in order to adjust energy consumption in a network, and
sending a notification comprising at least one derived energy saving measure to a network element.

According to various example embodiments, the at least one energy saving measure may further comprise adjusting charging based on varying the quality of service for the at least one user equipment.

According to various example embodiments, the method may further comprise deriving charging characteristic and criteria for which the said derived charging characteristic apply for the at least one user equipment for each energy saving measure, and sending the derived charging characteristic and criteria with the notification to the network element.

According to various example embodiments, the method may further comprise receiving a response notification from the network element, the response notification comprising information indicating whether the at least one user equipment will take part in the at least one energy saving measure or not, and/or whether the at least one user equipment accepts taking part in the at least one energy saving measure or not.

According to various example embodiments, the method may further comprise initiating a control of the quality of service based on the energy saving measure.

According to various example embodiments, the method may further comprise initiating, upon receiving and/or detecting a trigger, the control of the quality of service based on the energy saving measure.

According to various example embodiments, the method may further comprise deriving the energy saving measure by analyzing the condition of the network and predicting an impact of the energy saving measure on the energy consumed in the network based on history information.

According to various example embodiments, the history information may be information about a relationship between network conditions, network energy saving measures, and network energy consumption.

According to various example embodiments, the method may further comprise analyzing the condition of the network and predicting the impact of the energy saving measure by applying artificial intelligence.

According to various example embodiments, the method may further comprise deriving the at least one energy saving measure based on quality of service optimization guidelines preconfigured in the network, and preparing an energy saving offer based on the energy saving measure.

According a fifth aspect of various example embodiments, a method is provided which comprises
receiving a notification comprising at least one energy saving measure involving at least one user equipment, wherein the at least one energy saving measure comprises varying the quality of service for the at least one user equipment in order to adjust energy consumption in a network,
selecting at least one user equipment for taking part in the at least one energy saving measure,
determining whether the selected at least one user equipment will take part in the energy saving measure, and
applying the at least one energy saving measure for the selected at least one user equipment based on determining that the at least user equipment will take part in the energy saving measure.

According to various example embodiments, the energy saving measure may further comprise adjusting charging based on varying the quality of service for the at least one user equipment.

According to various example embodiments, the method may further comprise sending information as to whether the selected at least one user equipment will take part in the at least one energy saving measure to a network element having sent the notification.

According to various example embodiments, the method may further comprise determining whether the determined at least one user equipment will take part in the energy saving measure or not by sending a proposal for taking part in the energy saving measure to at least one determined user equipment, and receiving a response message from the user equipment.

According to various example embodiments, the method may further comprise sending the proposal for taking part in the energy saving measure to the user equipment in a packet session modification command.

According to various example embodiments, the proposal may comprise information about the change in quality of service as well as an impact on the charging in a human or machine readable format.

According to various example embodiments, the method may further comprise determining whether the selected at least one user equipment will take part in the at least one energy saving measure or not by accessing user equipment subscription data information stored in a network element.

According to various example embodiments, the user equipment subscription data information may comprise
information as to whether the user equipment agrees to take part in adjusting energy consumption in a network or not, and/or
information as to whether the user equipment agrees to take part in a certain energy saving measure or not, and/or
information as to whether the user equipment is to be notified about the energy saving measure that will be applied, and/or
information as to whether the user equipment is to be requested to verify whether the user equipment will take part in the energy saving measure before applying the energy saving measure, and/or
information as to whether the user equipment agrees to take part in adjusting energy consumption in a network or to take part in a certain energy saving measure during a predetermined time period and/or at a specific location and/or within a specific network slice.

According to various example embodiments, the method may further comprise sending, before applying the energy saving measure, a request to the user equipment to verify whether the user equipment will take part in the energy saving measure, in case: user equipment subscription data information comprises information that the user equipment is to be requested to verify whether the user equipment will take part in the energy saving measure before applying the energy saving measure, or when the request is pre-configured in the network.

According to various example embodiments, the method may further comprise sending, before applying the energy saving measure, an information to the user equipment that user equipment will take part in the energy saving measure, in case: user equipment subscription data information comprises information that the user equipment is to be notified about the energy saving measure that will be applied, or when sending the information is pre-configured in the network.

According to various example embodiments, the method may further comprise selecting the at least one user equipment based on information received from the network element.

According to various example embodiments, the information received from the network element may comprise for each energy saving measure charging characteristics and criteria for which the said derived charging characteristics apply for the at least one user equipment.

According to various example embodiments, the method may further comprise selecting at least one network element involved in the at least one energy measure based on the information received from the network element.

According a sixth aspect of various example embodiments, a method is provided which comprises
receiving a proposal for taking part in an energy saving measure, the proposal comprising information about at least one energy saving measure involving the user equipment, wherein the energy saving measure comprises varying the quality of service for the user equipment in order to adjust energy consumption in a network,
determining whether to accept the proposal or not, and
sending a response including information indicating whether the proposal is accepted or not.

According to various example embodiments, the energy saving measure may further comprise adjusting charging based on varying the quality of service for the at least one user equipment.

According to various example embodiments, the proposal may comprise a request to verify whether the user equipment will take part in the energy measure, and the method may further comprise determining whether to accept the proposal or not by verifying the proposal.

According to various example embodiments, the proposal may comprise a plurality of energy saving measures, and the method may further comprise selecting one energy saving measure from the plurality of energy measures.

According to various example embodiments, the method may further comprise determining whether to accept the proposal or not based on a pre-configuration or based on receiving user or machine input on whether or not to accept the offer, or by performing a predetermined process.

According a seventh aspect of various example embodiments, a computer program product is provided, which comprises code means for performing a method according to any one of the above fourth to sixths aspects of various example amendments when run on a processing means or module.

According to various example embodiments, the computer program product may be embodied on a computer-readable medium, and/or the computer program product may be directly loadable into the internal memory of the computer and/or transmittable via a network by means of at least one of upload, download and push procedures.

### BRIEF DESCRIPTION OF THE DRAWINGS

In the following, some example embodiments will be described in greater detail, by way of non-limiting and illustrative examples, with reference to the accompanying drawings, in which:

FIG. 1A shows a network element carrying out a service producer functionality according to some example embodiments,

FIG. 1B shows a procedure carried out by the network element according to some example embodiments,

FIG. 2A shows a CN NF (e.g., SMF) according to some example embodiments,

FIG. 2B shows a procedure carried out by the CN NF according to some example embodiments,

FIG. 3A shows a UE according to some example embodiments,

FIG. 3B shows a procedure carried out by the UE according to some example embodiments,

FIG. 4 shows a table illustrating an example of charging characteristics behaviours for SMF according to some example embodiments.

FIG. 5 shows a table illustrating an example of charging characteristics information configured in AMF according to some example embodiments.

FIGS. 6A-6E show a table illustrating default trigger conditions in SMF according to some example embodiments.

FIG. 7 shows a table illustrating default trigger conditions in SMF according to some example embodiments.

FIG. 8 shows a table illustrating PDU session related policy information according to some example embodiments.

FIG. 9 shows a table illustrating UE subscription data according to some example embodiments.

FIG. 10 shows a signal flow according to some example embodiments.

### DETAILED DESCRIPTION

In the following, description will be made to example embodiments. It is to be understood, however, that the description is given by way of example only, and that the described example embodiments are by no means to be understood as limiting.

Before describing example embodiments, in the following, some issue and/or problems and drawbacks addressed by various example embodiments are discussed in more detail.

In 3GPP SA5, multiple studies have been conducted and standard specification derived in the context of energy efficiency and energy consumption measurements and metrics.

For example, an on-going study in TR 28.913 has a key issue (key issue #5) that focuses on network slice customer (NSC) accepting energy saving via QoS degradation. In this context, NSC can decide to accept QoS degradation to save energy on the network side and they can specify which QoS degradation they are ready to accept as well as they can receive reports on the measured energy saving. QoS degradation can be expressed in various dimensions:

#The ‘what’: the NSC may be capable and willing to express that the NSC accepts, for example, degraded bandwidth and/or latency and/or number of simultaneously connected UEs, etc.

#The ‘how much’: the NSC may be capable and willing to express that the NSC accepts, for example, a 10% QoS degradation, a 50% QoS degradation, etc.

#The ‘when’: the NSC may be willing to express when the NSC accepts some time-limited QoS degradation, for example, dates, time slots, punctual (e.g. on identified labour days)/recurrent (e.g. all Saturdays and Sundays of the year), etc.

#The ‘where’: the NSC may be willing to express where the NSC accepts some space-limited QoS degradation, for example, in country X, in city Y, etc.

Network Slice Consumer (NSC) is enabled to provide energy saving guidelines as described in TR 28.913. The guidelines can be interpreted by the network slice provider (NSP) to apply QoS optimization for energy saving purposes. Such optimization may be limited not only in terms of “what”, “how much”, “when” and “where” but also “who”, for example, the UEs.

It could be that such QoS optimization may be applied to certain UEs based on subscription information or dynamic verification by the UE, which in turn may have impact on the charging aspects. However, there is no means to specify which UE or UE groups would be impacted by energy saving based QoS optimization. Consequently, there is also no method for energy saving based QoS optimization (e.g., UE charging adjustments based on energy saving based QoS optimization).

Hence, according to some example embodiments, the UE impact for QoS optimization is determined, and a process to enable (or otherwise facilitate) energy saving based QoS optimization (e.g., UE charging adjustments based on energy saving based QoS optimization) and corresponding communication is provided.

According to some example embodiments, procedures are proposed, by which it is possible to save energy in a network.

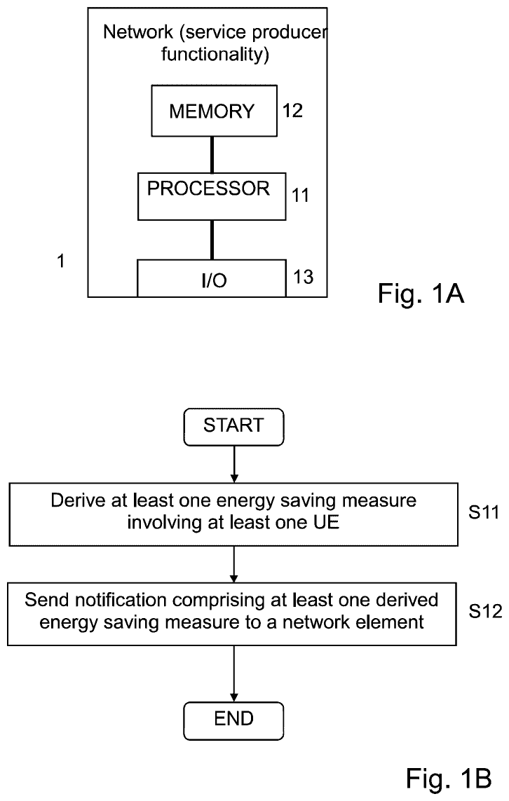

In the following, a general overview of some example embodiments is described by referring to FIGS. 1A, 1B, 2A, 2B, 3A and 3B.

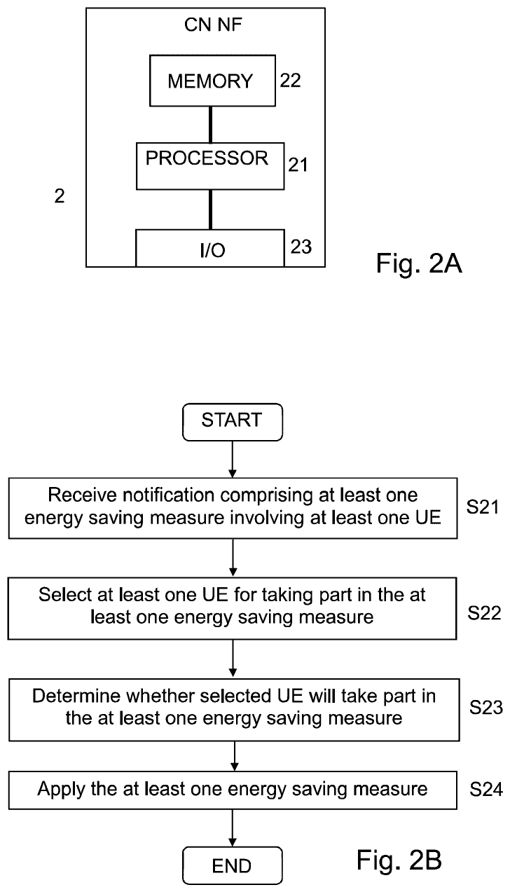

FIG. 1A shows a network control element 1 according to some example embodiments. The network control element is an example of an apparatus, which could be or be a part of a network control element comprising a service producer functionality, for example. A procedure carried out by the network control element 1 is illustrated in FIG. 1B. The network control element 1 shown in FIG. 1A comprises at least one processor 11 and at least one memory 12 storing instructions that, when executed by the at least one processor 11, cause the apparatus to perform: deriving (S11 in FIG. 1B) at least one energy saving measure involving at least one user equipment, wherein the energy saving measure comprises varying the quality of service for the at least one user equipment in order to adjust energy consumption in a network, and sending (S12 in FIG. 1B) a notification comprising at least one derived energy saving measure to a network element (e.g., CN NF 2 shown in FIG. 2A).

FIG. 2A shows a CN NF (e.g., SMF) 2 according to some example embodiments. The CN NF 2 is an example of an apparatus, which could be or be a part of a network element. Additionally or alternatively, the apparatus may be configured to operate as a network function, for example. A procedure carried out by the CN NF 2 is illustrated in FIG. 2B. The CN NF 2 shown in FIG. 2A comprises at least one processor 21 and at least one memory 22 storing instructions that, when executed by the at least one processor 21, cause the apparatus to perform: receiving (S21 in FIG. 2B) a notification comprising at least one energy saving measure involving at least one user equipment, wherein the at least one energy saving measure comprises varying the quality of service for the at least one user equipment in order to adjust energy consumption in a network, selecting (S22 in FIG. 2B) at least one user equipment for taking part in the at least one energy saving measure, determining (S23 in FIG. 2B) whether the selected at least one user equipment will take part in the energy saving measure, and applying (S24 in FIG. 2B) the at least one energy saving measure for the selected at least one user equipment based on determining that the at least user equipment will take part in the energy saving measure.

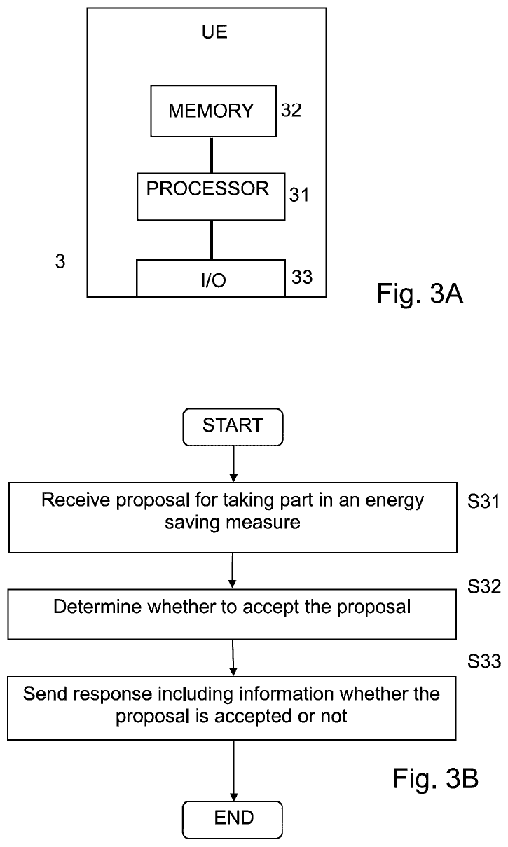

FIG. 3A shows a UE 3 according to some example embodiments. The UE 3 is an example of an apparatus, which could be or be a part of a user equipment, for example. A procedure carried out by the UE 3 is illustrated in FIG. 3B. The UE 3 shown in FIG. 3A comprises at least one processor 31 and at least one memory 32 storing instructions that, when executed by the at least one processor 31, cause the apparatus to perform: receiving (S31 in FIG. 3B) a proposal for taking part in an energy saving measure, the proposal comprising information about at least one energy saving measure involving the user equipment, wherein the energy saving measure comprises varying the quality of service for the user equipment in order to adjust energy consumption in a network, determining (S32 in FIG. 3B) whether to accept the proposal or not, and sending (S33 in FIG. 3B) a response including information indicating whether the proposal is accepted or not.

The apparatuses 1 to 3 shown in FIGS. 1A, 2A and 3A may comprise more components than described above, and may further comprise I/O units 13, 23, 33 which are configured to transmit to and receive from other network elements.

The energy saving measure may further comprise adjusting charging based on varying the quality of service for the at least one UE.

Thus, the server producer functionality 1 may derive (e.g. determine, produce) at least one energy saving measure involving at least one user entity (such as, the UE 3 shown in FIG. 3A), and may send a notification (message) including information about the at least one energy saving measure to a network element, such as the CN NF 2 shown in FIG. 2A. The CN NF 2 may select at least one UE for taking part in the at least one energy saving measure, and may determine whether the selected UE will take part in the at least one energy saving measure. If so, the CN NF 2 may apply the energy saving measure.

The CN NF 2 may determine whether the selected UE will take part in the energy saving measure by sending a proposal (or an energy saving (ES) offer) to the UE 3 (as an example for the selected UE). The UE may determine whether to accept the proposal (for example, by receiving a user input or by automatically providing a response based on a pre-configuration in the UE).

The CN NF 2 may determine whether the selected UE will take part in the energy saving measure by accessing user equipment subscription data information.

For example, the user equipment subscription data information may comprise one or more of the following:
information as to whether the UE agrees to take part in adjusting energy consumption in a network, or not,
information as to whether the UE agrees to take part in a certain energy saving measure or not,
information as to whether the UE is to be notified about the energy saving measure that will be applied,
information as to whether the UE is to be requested to verify whether the user equipment will take part in the energy saving measure before applying the energy saving measure,
information as to whether the UE agrees to take part in adjusting energy consumption in a network or to take part in a certain energy saving measure during a predetermined time period and/or at a specific location and/or a specific network slice.

The CN NF 2 may inform the server producer functionality 1 whether and which selected UE will take part in the at least one energy saving measure.

The service producer functionality 1 may derive the at least one energy saving measure by a mechanism in the service producer functionality 1 where the mechanism takes into account the QoS optimization guidelines and current network information including any FCAPS information, network condition, UE information (e.g. UE context, UE subscription information), predictive analysis on the potential energy saving in the network enabled by the derived measures, for example.

Energy saving measure derived by the service producer functionality 1 is provided to service producer 2 (CN NF 2) which then can derive energy saving offer/proposal for the UE. This proposal may be an ES (Energy Saving) offer, and the service producer functionality may also derive (and, for example, provide) associated charging characteristics and criteria for which the said derived charging characteristics apply. For example, the service producer functionality 1 may derive the at least one energy saving measure based on quality of service (QoS) optimization guidelines, which are preconfigured in the network or dynamically agreed during network operation between the network and the NSC, and may prepare an energy saving (ES) offer based on the energy saving measure.

In the following, the procedures described above are described in some more detail following by referring to some further detailed embodiments.

According to some example embodiments, a charging-based reimbursement is provided to incentivize the UE(s) to accept QoS optimization for network side energy saving (ES). In particular, the following is provided:

a. Introduction of new service producer functionality to derive ES offer for a UE(s), associated charging characteristics and criteria under which the offer and charging applies.

b. Extension of charging characteristics information and its availability in the network.

c. Extension of UE-network signaling for negotiation on the derived offers.

This is described in the following in more detail. First, the service producer functionality is described. According to some example embodiments, the service producer functionality is an entity (e.g., a network function) which produces or provides different kinds of services which may be used by UEs.

In particular, the service producer functionality determine, based on ES guidelines provided to the service producer, the following:
1) one or multiple ES offers (including the impact of ES on the UE, such as QoS change) for one or more UEs,
2) charging aspects associated with each ES offer and
3) criteria under which each ES offer applies.

Service producer can utilize AI to derive these. Such AI can consider various data and analytics available in the network, such as expected amount of energy saving in the network, FM/CM/PM data, UE behavioral analytics, slice load analytics, UE subscription data and/or UE context, expected UE side energy consumption change (derived intelligently e.g., by using information like traffic size, periodicity, burst characteristics information for different QoS classes for UE) when QoS optimization is applied.

Service producer can be in OAM (MnS) or in CN (CN NF).

Depending on the ES guidelines and how the service producer interprets the guidelines, the derived offer and associated charging characteristics may be (semi-)permanent and/or limited in terms of, for example, time or area for a UE(s).

Next, charging characteristics information is described. According to some example embodiments, charging characteristics information is information how a service provided or produced by the service producer is to be charged (e.g., that and to which extent charging is lowered when QoS is lowered).

Charging characteristics information (both for session and access, registration, and mobility) includes “network energy saving based charging method(s)”. This can be limited according to the ES guidelines (e.g., network slice, time, area, etc.). It can be configured to AMF and/or SMF or included in the subscription data stored at UDM.

ES offers and criteria, based on being permanent or temporary can be stored in subscription data at UDM or in UE context while the UE is registered to the network or even after the UE de-registers and the network decides to store the UE context for a predetermined time period based on operator configuration.

In the following, UE-network signaling according to some example embodiments is described.

In particular, according to some example embodiments, subscription data (both for session and access, registration, and mobility) can also include “network energy saving supported” parameter to aid the network in determining the UE(s) for which ES-based QoS optimization can be applied (together with criteria information). Such parameter can be “Yes” or “No”. Alternatively, it can be limited based on network slice, time, area, etc. It can also indicate whether the UE prefers to be notified before an ES offer is applied, UE prefers to verify the ES offer before it is applied, or the UE prefers not to be notified.

Once the service producer derives the ES offer(s) and associated features, it sends to corresponding service consumers in the core network (CN). CN determines the UE(s) that fit the criteria as well as the corresponding NFs (SMF, AMF, CHF, etc.), saves the information as described above (e.g., charging information in SMF and/or AMF or subscription data, ES offer in subscription data or UE context, etc.), applies the selected ES offer and its associated charging. If UE indicated that it prefers to be notified and/or prefers to verify ES offer by itself or based on operator policy, CN also sends a NAS message towards UE(s) about the ES offers and charging, for example in a human-readable format and/or machine-readable format.

CN sending NAS message to the UE(s) can occur either proactively (if network is capable of ES based QoS optimization) or based on a new trigger (if network is capable of ES based QoS optimization and network detected/received a trigger to apply ES based QoS optimization). UE-network communication for this purpose can be performed by extending existing NAS messages, namely registration, PDU session establishment and PDU session modification.

In case a UE(s) prefers to be notified and/or if operator policy dictates UE notification, UE(s) receives the NAS message and waits for the ES offer to be applied. In case a UE(s) prefers to verify the ES offer by itself and/or if operator policy dictates verification by UE, UE(s) analyze(s) the different ES offers and their charging, select(s) an ES offer and notify(ies) CN via NAS message.

In the following, some more detailed implementations according to example embodiments are described.

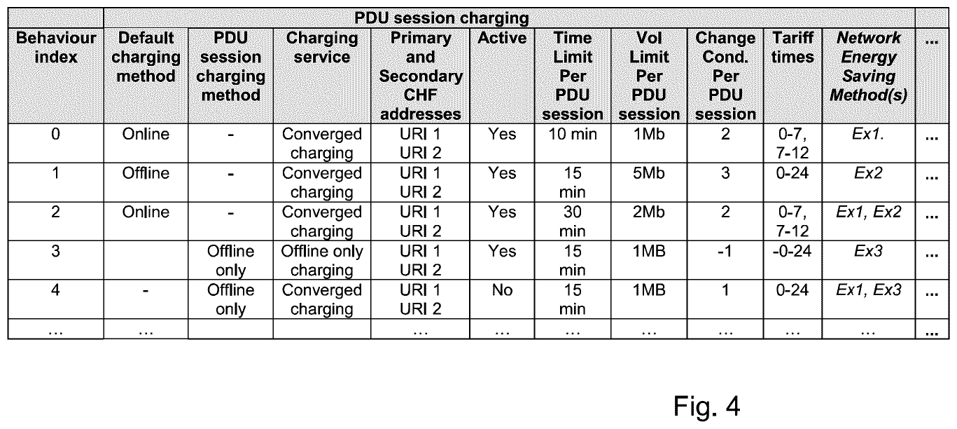

In particular, FIG. 4 shows a table in which an extension for charging characteristics information configured in SMF is shown, which is based on TS 32.255, Annex A.

The table shown in FIG. 4 includes network side energy saving related charging methods according to some example embodiments as a new column on the right side. The charging methods for network energy saving may be same or different than default and PDU session charging methods according to the energy saving guidelines and/or operator implementation/configuration. The content of the column is implementation specific.

In the example shown in FIG. 4, different examples for network energy saving methods Ex1, Ex2 and Ex3 are shown. It is noted that for each behavior index, one or more network energy saving method may be present. Moreover, for some behavior indexes, also no energy saving method may be present.

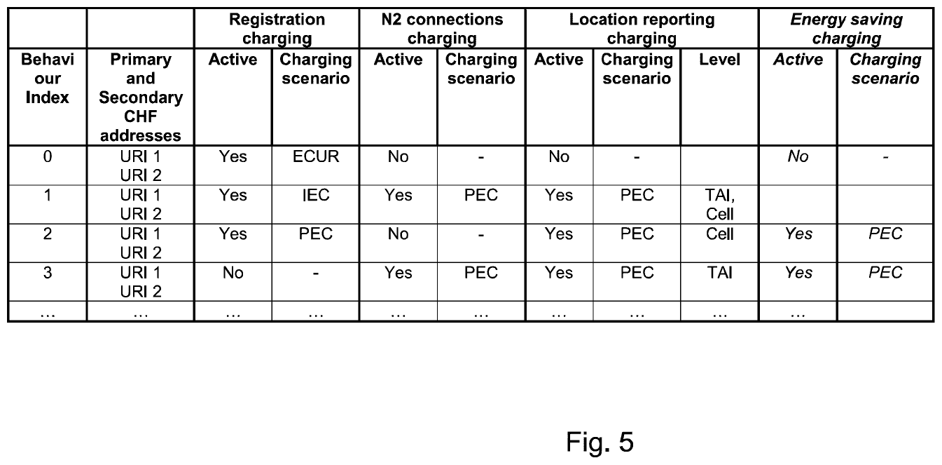

FIG. 5 shows a table in which an extension for charging characteristics information configured in AMF is shown, which is based on TS 32.256, Annex A.

In particular, the AMF charging profile is defined to allow AMF to determine applicable charging trigger conditions for registration, N2 connection charging and location reporting. The default AMF charging profile is provided by the Charging Characteristics. According to some example embodiments, an extension of such charging profile is provided to include charging characteristics related to energy saving offers. In the table shown in FIG. 5, a column is added on the right side (“Energy saving charging”), which comprises two sub-columns “Active” and “Charging scenario”. As also mentioned above in connection with FIG. 4, for some behavior indexes, no energy saving method may be present.

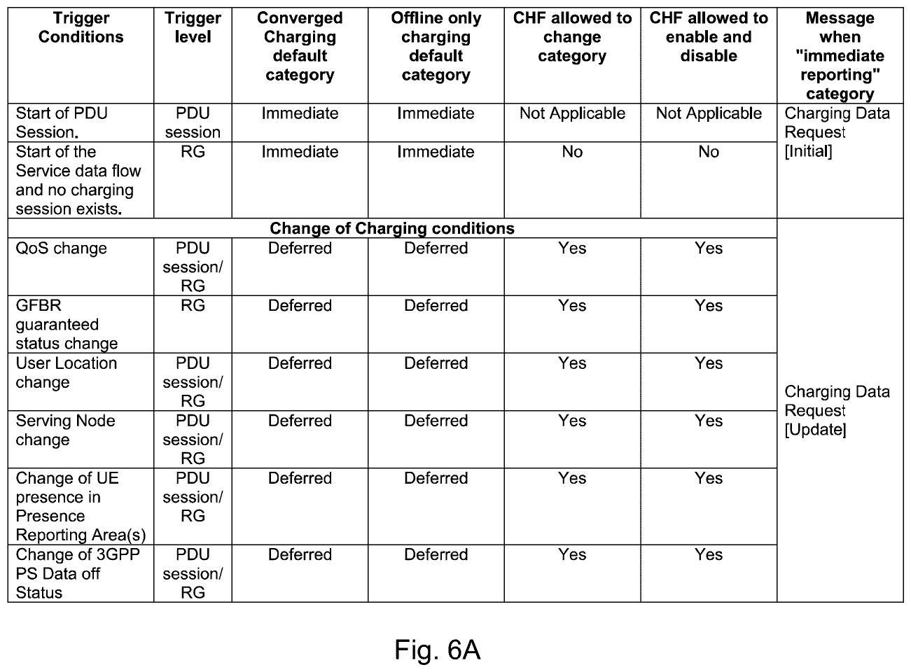

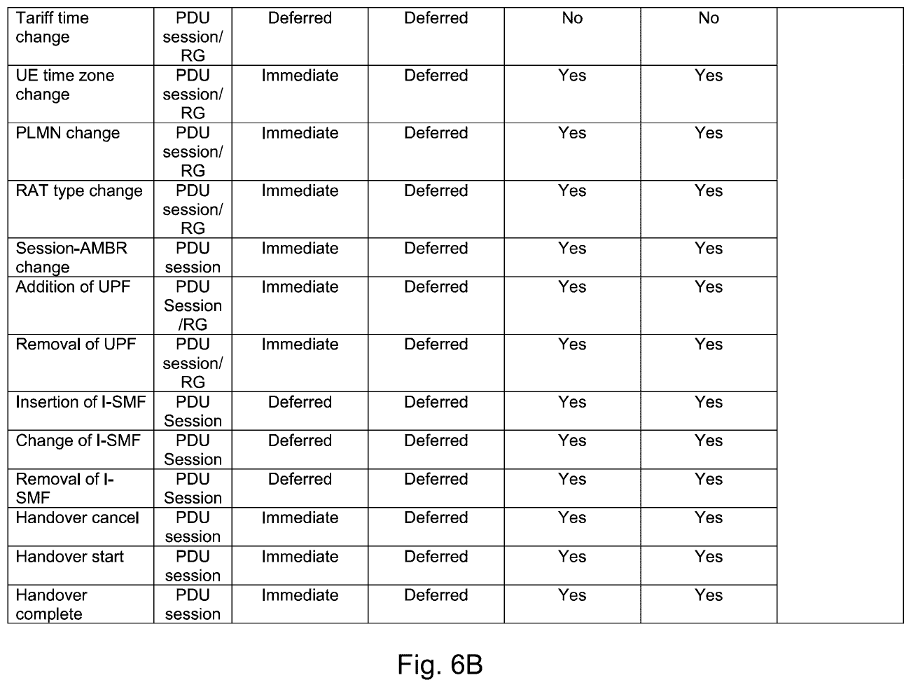

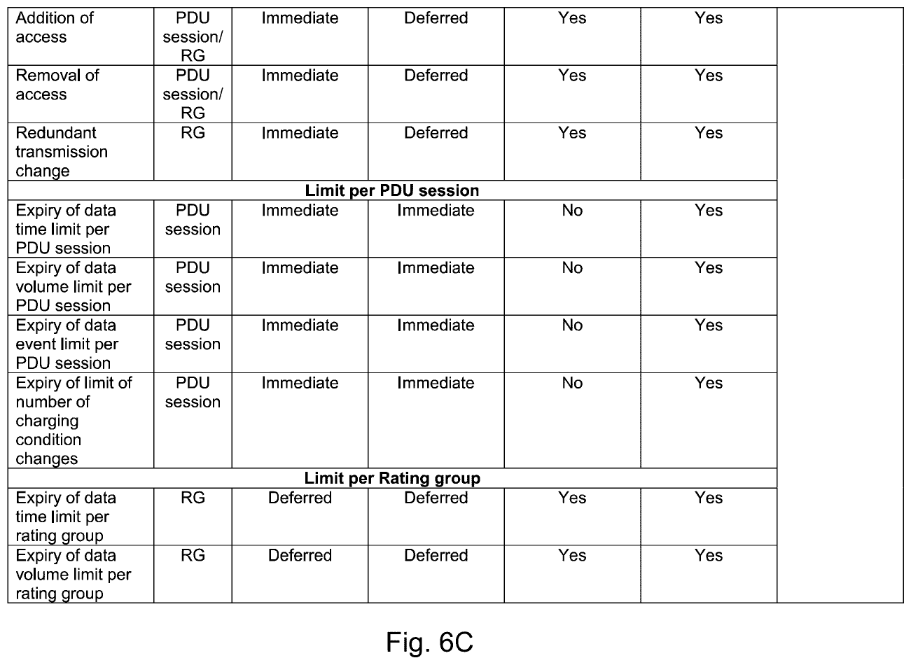

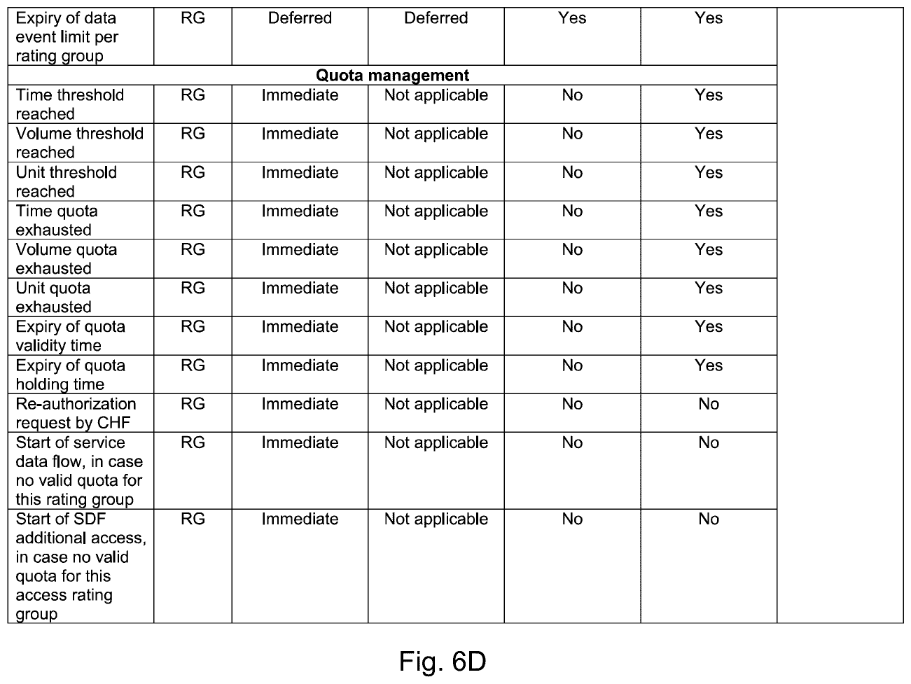

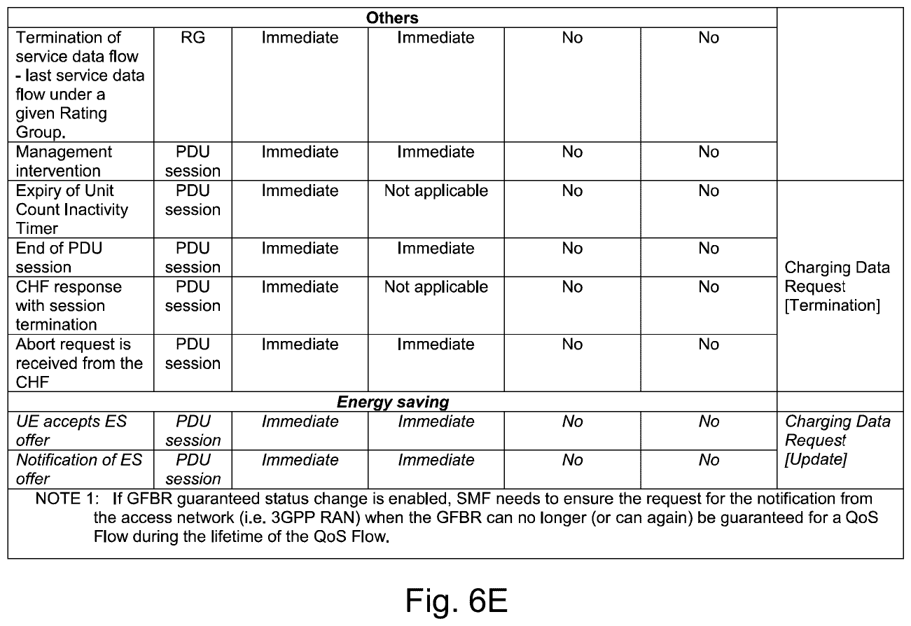

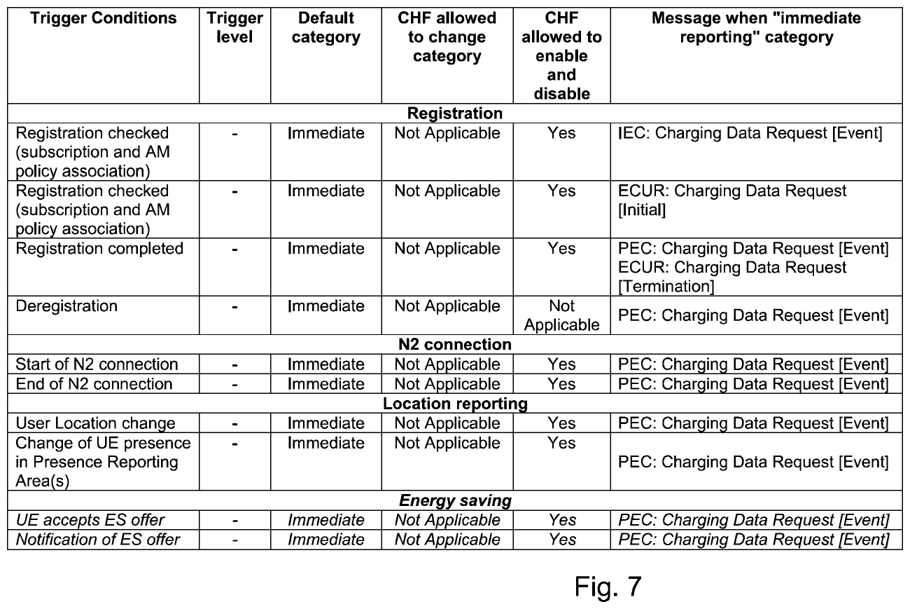

The charging may be performed by the SMF/AMF or other impacted NFs interacting with CHF as specified in TS 32.255 and TS 32.256, respectively. The Charging Data Request and Charging Data Response are exchanged between the SMF/AMF and the CHF. The Charging Data Request is issued by the SMF/AMF towards the CHF when energy saving conditions are met or the energy saving offer has been accepted by the UE. The energy saving conditions/events are proposed to be added to the list of charging events. One example of such event is illustrated in tables shown in FIGS. 6A-6E and 7 (marked in italic) for SMF and AMF, respectively.

The table shown in FIGS. 6A-6E is based on table 5.2.1.4.1 of TS 32.255 and illustrates default trigger conditions in SMF. According to some example embodiments, two new trigger conditions are defined, namely “UE accepts ES offer” and “Notification of ES offer”. For both cases, the trigger level is defined by the PDU session, the converged charging default category is “immediate’”, and the offline charging default category is “immediate”. In both cases, the CHF allowed to change category and CHF allowed to enable and disable are “NO”. The message when “immediate reporting” category is “Charging Data Request [Update]”.

The table shown in FIG. 7 is based on table 5.2.1.2.1.1 of TS 32.256 and illustrates default trigger conditions in AMF. According to some example embodiments, similar as described above in connection with FIGS. 6A-6E, two new trigger conditions are defined, namely “UE accepts ES offer” and “Notification of ES offer”. For both cases, no the trigger level is defined, and the default category is “immediate’”, and the offline charging default category is “immediate”. In both, the CHF allowed to change category is not applicable and CHF allowed to enable and disable is “NO”. The message when “immediate reporting” category is “PEC: Charging Data Request [Event]”.

The trigger for charging update results in CDR generation. For energy saving based charging updates, CDR parameters can be extended as follows (TS 32.298):
Service level CDR parameters are extended with a new category “Network energy saving CDR parameters”.
Network energy saving CDR parameters includes at least “User identifier” (user identifier), “ES offer” (accepted offer details), “List of Locations” (information on the applicable locations for the ES offer), “List of Time Intervals” (information on the applicable timeframe for the ES offer).

Additionally, subscriber spending limits may be different when network energy saving is applied. A new policy counter identifier for energy saving purposes is created and kept track by the PCF. This is notified to CHF. CHF can use the policy counter identifier to receive spending limit information from PCF.

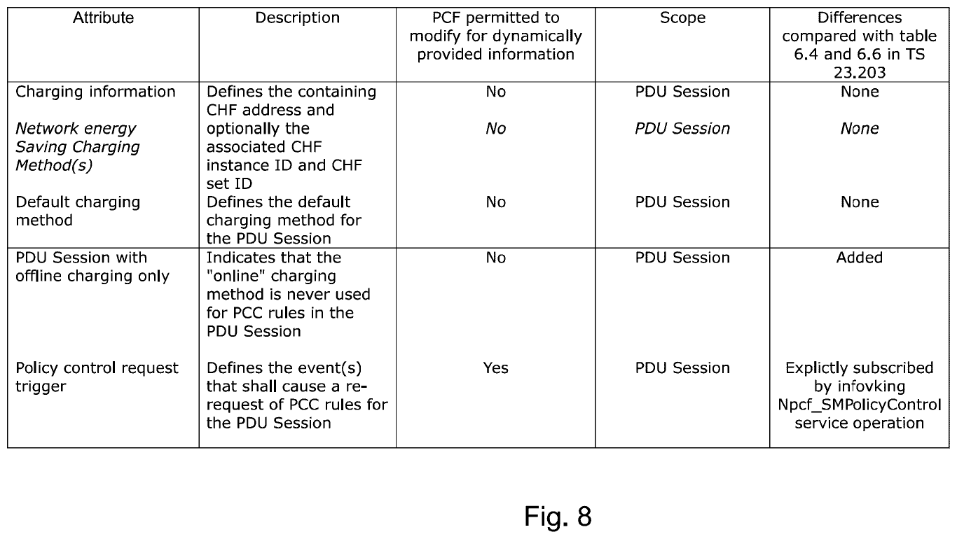

FIG. 8 shows a table, which is based on table 6.4-1 of TS 23.503, in which a proposed extension (in italic) to session management related policy information including the new charging characteristics information is illustrated. In particular, a new attribute is added, namely Network Energy Saving Charging Method(s).

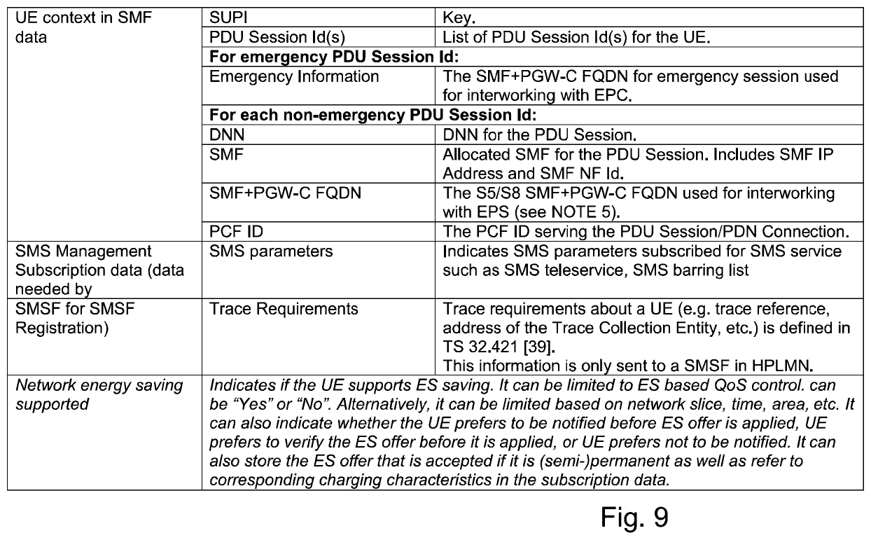

FIG. 9 shows a table, which is based on table 5.2.3.3.1-1 of TS 23.502 and which illustrates a proposed extension to UE subscription data for network energy saving.

In particular, a new parameter “Network energy saving supported” is added to the subscription data. As mentioned above, this parameter indicates if the UE supports ES saving. It can be limited to ES based QoS control. The parameter can be “Yes” or “No”. Alternatively, it can be limited based on network slice, time, area, etc. It can also indicate whether the UE prefers to be notified before ES offer is applied, UE prefers to verify the ES offer before it is applied, or UE prefers not to be notified. It can also store the ES offer that is accepted if it is (semi-)permanent as well as refer to corresponding charging characteristics in the subscription data.

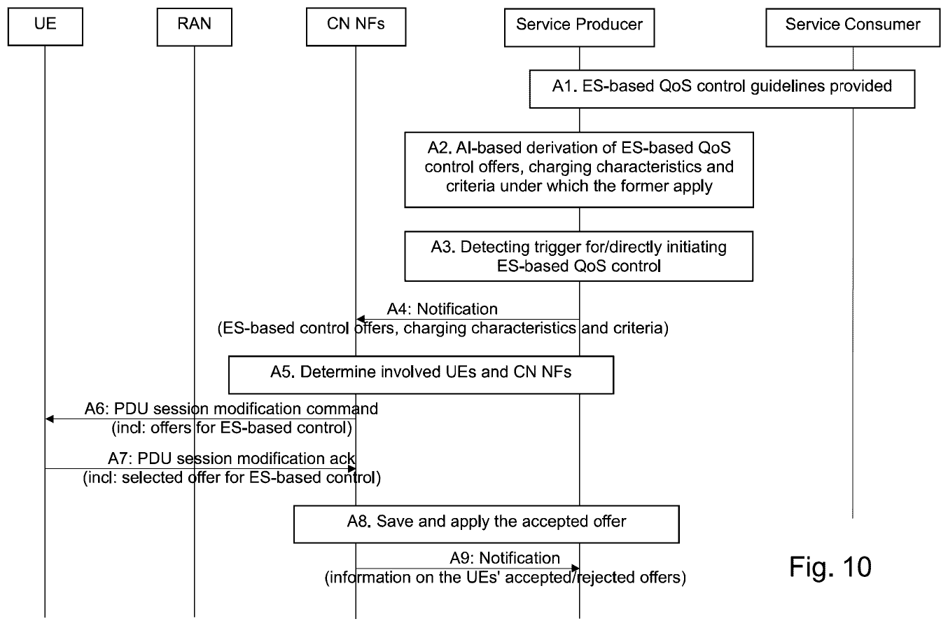

FIG. 10 shows a signal flow, in which an overall process according to some example embodiments is illustrated, including derivation of ES offers, making any related optimized QoS information in the network and UE-network signaling. More specifically, this signal flow (call flow) is based on UE verification of ES offer(s) and PDU session based signaling.

In A1, ES based QoS optimization guidelines are established between service consumer and service producer.

In A2, the service producer derives ES offers, associated charging characteristics and criteria. This is derived via an ML model taking into account various information (e.g., amount of energy expected to be saved in the network, FM/PM/CM data, UE behavioral analytics, Slice load analytics, UE subscription/UE context, relative UE side energy saving for different offers and QoS classes). Alternative to an ML model, any method that implements a corresponding computation logic can be used.

In A3, in case of a trigger-based ES-based QoS control initiation, service producer detects a trigger based on a monitoring mechanism either by the service producer itself or by another network entity (or other network entities) that is (are) delegated to perform the monitoring.

In A4, the service producer communicates with corresponding CN NFs (e.g., to configure the charging characteristics in the NFs, etc.). In particular, it sends a notification including ES-based QoS control offers, charging characteristics and criteria to the corresponding CN NFs.

In A5, the impacted CN NFs (e.g., SMF) determine the impacted UEs and further impacted CN NFs based on criteria, UE subscription data and operator policy.

In A6, if the network-UE signaling should be performed, assuming UE already has an established PDU session, a PDU session modification message (PDU session modification command) is sent towards the UE including ES offers and charging information in a (human/machine)-readable format.

In A7, if the network-UE signaling should be performed, UE selects an ES offer and sends this in a PDU session modification response message (PDU session modification ack). Note that the selection/rejection of offers can be done either manually by the UE (human operated terminal) or by some smart App residing inside the UE (in case of a UE that is not operated by a human).

In A8, if the response message includes a selected ES offer, CN NF (e.g., SMF) informs related CN NFs (e.g., PCF, CHF) for applying related charging for the selected ES offer. The information on the accepted offer is saved e.g., in UE context information or subscription data. This saved information may contain impacts on saved UE information, including the session-related information and charging information.

In A9, the CN NF (e.g., SMF) notifies the service producer on the applied or rejected ES offer(s). This notification may comprise information on the UE's accepted/rejected offers.

It is noted that the above processes A6 and A7 are not carried out in case it is not necessary to request the UE to verify the offer, for example because the UE subscription data already indicates that the UE will accept the offer.

Moreover in A7, the smart App or a similar application, which is configured to carry out the selection/verification in the UE in case of a UE that is not operated by a human, may also be present in a human-operated UE, for example when the user of the UE prefers that the selection is carried out automatically. The smart App (smart application) is an example for a predetermined process carried out in the UE. Moreover, instead of an input by user, such an input can also be machine input, such as in an IoT device that does not have a time-sensitive task.

Hence, according to some example embodiments, a process for ES-based QoS control offers and associated signaling are provided. In particular, according to some example embodiments, ES-based QoS control offers and associated charging characteristics and criteria at newly introduced service producer functionality are derived. The service producer functionality sends ES-based QoS control offers and associated charging characteristics and criteria to corresponding CN NF (e.g. SMF). The CN NF determines the impacted UEs based on criteria, UE subscription data, and operator policy. A PDU session modification message is sent to the UE including ES offers and charging information in a human-readable format and/or machine-readable format. UE selects an ES offer and sends this in the PDU session modification response message. CN NF (e.g., SMF) informs related CN NFs (e.g., PCF, CHF) for applying related charging and applies the optimized QoS in the selected ES offer.

The various example embodiments of the subject disclosure are only examples and may be modified.

Names of network elements, protocols, and methods are based on standard terminology. In other versions or other technologies, the names of these network elements and/or protocols and/or methods may be different, as long as they provide a corresponding functionality.

In general, some example embodiments may be implemented by computer software stored in the memory (memory resources, memory circuitry) 12, 22, 32 and executable by the processor (processing resources, processing circuitry) 11, 21, 31 or by hardware, or by a combination of software and/or firmware and hardware.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein, two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting and illustrative examples.

The memory (memory resources, memory circuitry) 12, 22, 32 may be of any type suitable to the local technical environment and may be implemented using any suitable data storage technology, such as semiconductor based memory devices, magnetic memory devices and systems, optical memory devices and systems, fixed memory and removable memory, and non-transitory computer-readable media. The processor (processing resources, processing circuitry) 11, 21, 32 may be of any type suitable to the local technical environment, and may include one or more of general purpose computers, special purpose computers, microprocessors, digital signal processors (DSPs) and processors based on a multi core processor architecture, as non-limiting examples.

Further, as used herein, the term “circuitry” may refer to one or more or all of the following example embodiments:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

The term “non-transitory”, as used herein, is a limitation of the medium itself (i.e., tangible, not a signal) as opposed to a limitation on data storage persistency (e.g., RAM vs. ROM).

It is noted that, as used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

It is to be understood that the various example embodiments of the subject disclosure are illustrative and non-limiting and are not intended to be construed as limiting. Various modifications and applications may be apparent to those skilled in the art without departing from the spirit and scope of the various example embodiments of the subject disclosure.

According to various example embodiments, an apparatus is provided which comprises at least one processor and at least one memory storing instructions that, when executed the at least one processor, cause the apparatus at least to perform: deriving at least one energy saving measure involving at least one user equipment, wherein the energy saving measure comprises varying the quality of service for the at least one user equipment in order to adjust energy consumption in a network, and sending a notification comprising at least one derived energy saving measure to a network element.

According to various example embodiments, the at least one energy saving measure may further comprise adjusting charging based on varying the quality of service for the at least one user equipment.

According to various example embodiments, the at least one memory and the computer program code may be configured to, with the at least one processor, cause the apparatus to further perform: deriving charging characteristic and criteria for which the said derived charging characteristic apply for the at least one user equipment for each energy saving measure, and sending the derived charging characteristic and criteria with the notification to the network element.

According to various example embodiments, the at least one memory and the computer program code may be configured to, with the at least one processor, cause the apparatus to further perform: receiving a response notification from the network element, the response notification comprising information indicating whether the at least one user equipment will take part in the at least one energy saving measure or not, and/or whether the at least one user equipment accepts taking part in the at least one energy saving measure or not.

According to various example embodiments, the at least one memory and the computer program code may be configured to, with the at least one processor, cause the apparatus to further perform: initiating a control of the quality of service based on the energy saving measure.

According to various example embodiments, the at least one memory and the computer program code may be configured to, with the at least one processor, cause the apparatus to further perform: initiating, upon receiving and/or detecting a trigger, the control of the quality of service based on the energy saving measure.

According to various example embodiments, the at least one memory and the computer program code may be configured to, with the at least one processor, cause the apparatus to further perform: deriving the energy saving measure by analyzing the condition of the network and predicting an impact of the energy saving measure on the energy consumed in the network based on history information.

According to various example embodiments, the history information may be information about a relationship between network conditions, network energy saving measures, and network energy consumption.

According to various example embodiments, the at least one memory and the computer program code may be configured to, with the at least one processor, cause the apparatus to further perform: analyzing the condition of the network and predicting the impact of the energy saving measure by applying artificial intelligence.

According to various example embodiments, the at least one memory and the computer program code may be configured to, with the at least one processor, cause the apparatus to further perform: deriving the at least one energy saving measure based on quality of service optimization guidelines preconfigured in the network, and preparing an energy saving offer based on the energy saving measure.

According to various example embodiments, an apparatus is provided, which comprises at least one processor and at least one memory storing instructions, that, when executed by the at least one processor, cause the apparatus at least to perform: receiving a notification comprising at least one energy saving measure involving at least one user equipment, wherein the at least one energy saving measure comprises varying the quality of service for the at least one user equipment in order to adjust energy consumption in a network, selecting at least one user equipment for taking part in the at least one energy saving measure, determining whether the selected at least one user equipment will take part in the energy saving measure, and applying the at least one energy saving measure for the selected at least one user equipment based on determining that the at least user equipment will take part in the energy saving measure.

According to various example embodiments, the energy saving measure may further comprise adjusting charging based on varying the quality of service for the at least one user equipment.

According to various example embodiments, the at least one memory and the computer program code may be configured to, with the at least one processor, cause the apparatus to further perform: sending information as to whether the selected at least one user equipment will take part in the at least one energy saving measure to a network element having sent the notification.

According to various example embodiments, the at least one memory and the computer program code may be configured to, with the at least one processor, cause the apparatus to further perform: determining whether the determined at least one user equipment will take part in the energy saving measure or not by sending a proposal for taking part in the energy saving measure to at least one determined user equipment, and receiving a response message from the user equipment.

According to various example embodiments, the at least one memory and the computer program code may be configured to, with the at least one processor, cause the apparatus to further perform: sending the proposal for taking part in the energy saving measure to the user equipment in a packet session modification command.

According to various example embodiments, the proposal may comprise information about the change in quality of service as well as an impact on the charging in a human or machine readable format.

According to various example embodiments, the at least one memory and the computer program code may be configured to, with the at least one processor, cause the apparatus to further perform: determining whether the selected at least one user equipment will take part in the at least one energy saving measure or not by accessing user equipment subscription data information stored in a network element.

According to various example embodiments, the user equipment subscription data information may comprise information as to whether the user equipment agrees to take part in adjusting energy consumption in a network or not, and/or information as to whether the user equipment agrees to take part in a certain energy saving measure or not, and/or information as to whether the user equipment is to be notified about the energy saving measure that will be applied, and/or information as to whether the user equipment is to be requested to verify whether the user equipment will take part in the energy saving measure before applying the energy saving measure, and/or information as to whether the user equipment agrees to take part in adjusting energy consumption in a network or to take part in a certain energy saving measure during a predetermined time period and/or at a specific location and/or within a specific network slice.

According to various example embodiments, the at least one memory and the computer program code may be configured to, with the at least one processor, cause the apparatus to further perform: sending, before applying the energy saving measure, a request to the user equipment to verify whether the user equipment will take part in the energy saving measure, in case user equipment subscription data information comprises information that the user equipment is to be requested to verify whether the user equipment will take part in the energy saving measure before applying the energy saving measure, or when the request is pre-configured in the network.

According to various example embodiments, the at least one memory and the computer program code may be configured to, with the at least one processor, cause the apparatus to further perform: sending, before applying the energy saving measure, an information to the user equipment that user equipment will take part in the energy saving measure, in case: user equipment subscription data information comprises information that the user equipment is to be notified about the energy saving measure that will be applied, or when sending the information is pre-configured in the network.

According to various example embodiments, the at least one memory and the computer program code may be configured to, with the at least one processor, cause the apparatus to further perform: selecting the at least one user equipment based on information received from the network element.

According to various example embodiments, the information received from the network element may comprise for each energy saving measure charging characteristics and criteria for which the said derived charging characteristics apply for the at least one user equipment.

According to various example embodiments, the at least one memory and the computer program code may be configured to, with the at least one processor, cause the apparatus to further perform: selecting at least one network element involved in the at least one energy measure based on the information received from the network element.

According to various example embodiments, an apparatus is provided which comprises at least one processor and at least one memory storing instructions, that, when executed by the at least one processor, cause the apparatus at least to perform: receiving a proposal for taking part in an energy saving measure, the proposal comprising information about at least one energy saving measure involving the user equipment, wherein the energy saving measure comprises varying the quality of service for the user equipment in order to adjust energy consumption in a network, determining whether to accept the proposal or not, and sending a response including information indicating whether the proposal is accepted or not.

According to various example embodiments, the energy saving measure may further comprise adjusting charging based on varying the quality of service for the at least one user equipment.

According to various example embodiments, the proposal may comprise a request to verify whether the user equipment will take part in the energy measure, and the at least one memory and the computer program code may be configured to, with the at least one processor, cause the apparatus to further perform: determining whether to accept the proposal or not by verifying the proposal.

According to various example embodiments, the proposal may comprise a plurality of energy saving measures, and the at least one memory and the computer program code may be configured to, with the at least one processor, cause the apparatus to further perform: selecting one energy saving measure from the plurality of energy measures.

According to various example embodiments, the at least one memory and the computer program code may be configured to, with the at least one processor, cause the apparatus to further perform: determining whether to accept the proposal or not based on a pre-configuration or receiving user or machine input on whether or not to accept the offer, or by performing a predetermined process.

1. An apparatus comprising at least one processor and at least one memory storing instructions that, when executed by the at least one processor, cause the apparatus to perform:
deriving at least one energy saving measure involving at least one user equipment, wherein the energy saving measure comprises varying the quality of service for the at least one user equipment in order to adjust energy consumption in a network, and
sending a notification comprising at least one derived energy saving measure to a network element.

2. The apparatus according to claim 1, wherein the instructions, when executed by the at least one processor, further cause the apparatus to perform:
deriving charging characteristic and criteria for which the said derived charging characteristic apply for the at least one user equipment for each energy saving measure, and
sending the derived charging characteristic and criteria with the notification to the network element.

3. The apparatus according to claim 1, wherein the instructions, when executed by the at least one processor, further cause the apparatus to perform:
receiving a response notification from the network element, the response notification comprising information indicating whether the at least one user equipment will take part in the at least one energy saving measure or not, and/or whether the at least one user equipment accepts taking part in the at least one energy saving measure or not.

4. The apparatus according to claim 1, wherein the instructions, when executed by the at least one processor, further cause the apparatus to perform:
initiating a control of the quality of service based on the energy saving measure.

5. The apparatus according to claim 4, wherein the instructions, when executed by the at least one processor, further cause the apparatus to perform:
initiating, upon receiving and/or detecting a trigger, the control of the quality of service based on the energy saving measure.

6. The apparatus according to claim 1, wherein the instructions, when executed by the at least one processor, further cause the apparatus to perform:
deriving the energy saving measure by analyzing the condition of the network and predicting an impact of the energy saving measure on the energy consumed in the network based on history information.

7. The apparatus according to claim 6, wherein the history information is information about a relationship between network conditions, network energy saving measures, and network energy consumption.

8. The apparatus according to claim 6, wherein the instructions, when executed by the at least one processor, further cause the apparatus to perform:
analyzing the condition of the network and predicting the impact of the energy saving measure by applying artificial intelligence.

9. An apparatus comprising at least one processor and at least one memory storing instructions that, when executed by the at least one processor, cause the apparatus to perform:
receiving a notification comprising at least one energy saving measure involving at least one user equipment, wherein the at least one energy saving measure comprises varying the quality of service for the at least one user equipment in order to adjust energy consumption in a network,
selecting at least one user equipment for taking part in the at least one energy saving measure,
determining whether the selected at least one user equipment will take part in the energy saving measure, and
applying the at least one energy saving measure for the selected at least one user equipment based on determining that the at least user equipment will take part in the energy saving measure.

10. The apparatus according to claim 9, wherein the instructions, when executed by the at least one processor, further cause the apparatus to perform:
sending information as to whether the selected at least one user equipment will take part in the at least one energy saving measure to a network element having sent the notification.

11. The apparatus according to claim 9, wherein the instructions, when executed by the at least one processor, further cause the apparatus to perform:
determining whether the determined at least one user equipment will take part in the energy saving measure or not by
sending a proposal for taking part in the energy saving measure to at least one determined user equipment, and
receiving a response message from the user equipment.

12. The apparatus according to claim 11, wherein the proposal comprises information about the change in quality of service as well as an impact on the charging in a human or machine readable format.

13. The apparatus according to claim 9, wherein the instructions, when executed by the at least one processor, further cause the apparatus to perform:
determining whether the selected at least one user equipment will take part in the at least one energy saving measure or not by
accessing user equipment subscription data information stored in a network element.

14. The apparatus according to claim 13, wherein the user equipment subscription data information comprises:
information as to whether the user equipment agrees to take part in adjusting energy consumption in a network or not, and/or
information as to whether the user equipment agrees to take part in a certain energy saving measure or not, and/or
information as to whether the user equipment is to be notified about the energy saving measure that will be applied, and/or
information as to whether the user equipment is to be requested to verify whether the user equipment will take part in the energy saving measure before applying the energy saving measure, and/or
information as to whether the user equipment agrees to take part in adjusting energy consumption in a network or to take part in a certain energy saving measure during a predetermined time period and/or at a specific location and/or within a specific network slice.

15. The apparatus according to claim 9, wherein the instructions, when executed by the at least one processor, further cause the apparatus to perform:
sending, before applying the energy saving measure, a request to the user equipment to verify whether the user equipment will take part in the energy saving measure, in case:
user equipment subscription data information comprises information that the user equipment is to be requested to verify whether the user equipment will take part in the energy saving measure before applying the energy saving measure, or
when the request is pre-configured in the network.

16. The apparatus according to claim 9, wherein the instructions, when executed by the at least one processor, further cause the apparatus to perform:
sending, before applying the energy saving measure, an information to the user equipment that user equipment will take part in the energy saving measure, in case:
user equipment subscription data information comprises information that the user equipment is to be notified about the energy saving measure that will be applied, or
when sending the information is pre-configured in the network.

17. The apparatus according to claim 9, wherein the instructions, when executed by the at least one processor, further cause the apparatus to perform:
selecting the at least one user equipment based on information received from the network element.

18. The apparatus according to claim 17, wherein the information received from the network element comprises for each energy saving measure charging characteristics and criteria for which the said derived charging characteristics apply for the at least one user equipment.

19. The apparatus according to claim 17, wherein the instructions, when executed by the at least one processor, further cause the apparatus to perform:
selecting at least one network element involved in the at least one energy measure based on the information received from the network element.

20. An apparatus comprising at least one processor and at least one memory storing instructions that, when executed by the at least one processor, cause the apparatus to perform:
receiving a proposal for taking part in an energy saving measure, the proposal comprising information about at least one energy saving measure involving the user equipment, wherein the energy saving measure comprises varying the quality of service for the user equipment in order to adjust energy consumption in a network,
determining whether to accept the proposal or not, and
sending a response including information indicating whether the proposal 25 is accepted or not.

21. The apparatus according to claim 20, wherein the proposal comprises a request to verify whether the user equipment will take part in the energy measure, and the apparatus further comprises
means for determining whether to accept the proposal or not by verifying the proposal.

22. The apparatus according to claim 20, wherein the proposal comprises a plurality of energy saving measures, and wherein the instructions, when executed by the at least one processor, further cause the apparatus to perform:
selecting one energy saving measure from the plurality of energy measures.

23. The apparatus according to claim 20, wherein the instructions, when executed by the at least one processor, further cause the apparatus to perform:
determining whether to accept the proposal or not based on
a pre-configuration or
receiving user or machine input on whether or not to accept the offer, or
by performing a predetermined process.

24. The apparatus according to claim 1, wherein the at least one energy saving measure further comprises adjusting charging based on varying the quality of service for the at least one user equipment.

25. A method comprising:
deriving at least one energy saving measure involving at least one user equipment, wherein the energy saving measure comprises varying the quality of service for the at least one user equipment in order to adjust energy consumption in a network, and
sending a notification comprising at least one derived energy saving measure to a network element.

26. A method comprising:
receiving a notification comprising at least one energy saving measure involving at least one user equipment, wherein the at least one energy saving measure comprises varying the quality of service for the at least one user equipment in order to adjust energy consumption in a network,
selecting at least one user equipment for taking part in the at least one energy saving measure,
determining whether the selected at least one user equipment will take part in the energy saving measure, and
applying the at least one energy saving measure for the selected at least one user equipment based on determining that the at least user equipment will take part in the energy saving measure.

27. A method comprising:
receiving a proposal for taking part in an energy saving measure, the proposal comprising information about at least one energy saving measure involving the user equipment, wherein the energy saving measure comprises varying the quality of service for the user equipment in order to adjust energy consumption in a network,
determining whether to accept the proposal or not, and
sending a response including information indicating whether the proposal is accepted or not.
